(19) United States
(12) Patent Application Publication
(10) Pub. No.: US 2003/0209882 A1
(43) Pub. Date: Nov. 13, 2003

(54) Safety lock structure for strollers

(76) Inventor: Chuan-Ming Yeh, Chia-I Hsien (TW)

Correspondence Address: BIRCH, STEWART, KOLASCH & BIRCH, LLP, P.O. Box 747, Falls Church, VA, 22040-0747, US

(21) Appl. No.: 10/436,199

(22) Filed: May 13, 2003

(30) Foreign Application Priority Data
May 13, 2002 (CN) 02227408.1

(51) Int. Cl. B62B 7/06

(52) U.S. Cl. 280/642

(57) ABSTRACT

A safety lock structure for strollers has a pedal mounted on the handle tube to couple with a latch strut located on a linkage plate. When the folding structure is released, the stroller frame is partly collapsed initially and the pedal and the latch strut form a latched condition to remind users that the frame is collapsible and must be stopped from completely folding to prevent hurting the child sitting on the stroller. When it is intended to collapse the frame, move the pedal downwards to release the latched condition of the latch strut and the pedal, then the frame may be folded and collapsed completely.

### FIELD OF THE INVENTION

The invention relates to a safety lock structure for strollers that has a pedal to stop the movement of the stroller frame during the initial folding operation and releases a latch strut located on a linkage plate, to allow the stroller frame to continue the remained folding operations.

### BACKGROUND OF THE INVENTION

General strollers usually may be extended to a use position for carrying a young child and folded to a collapsed position. As the stroller frame mainly consists of a plurality of tubes that are pivotally engaged with one another, and the tubes are folded and crossed with one another while folding, it is quite risky if there is a child sitting on the stroller while folding. Hence the strollers generally have a folding safety lock to prevent users from folding the frame incidentally or by mistake. However, the safety lock usually is coupled with a release mechanism. For instance, U.S. Pat. No. 6,068,284 discloses such a design. In these inventions, the safety lock has to be released to operate the folding structure and release the stroller frame. As the safety lock structure is installed on the same location where the release mechanism is installed, the safety lock structure must be released before folding. But the stroller frame starts collapsing when the safety lock structure is released. Consumers tend to make erroneous operations and dangers might occur, because they don't know how to use the stroller.

### SUMMARY OF THE INVENTION

In view of the aforesaid disadvantages of conventional safety lock structures and the drawback that they permit, only one operating direction, and being not adaptable to people's habits of using different hands, the primary object of the invention is to provide a safety lock structure for strollers that has a pedal mounted on the handle tube coupling with a latch strut, located on a linkage plate such, that when the folding structure is released the stroller frame is folded partially first, and the pedal and the latch strut form a latched condition to remind users of the movements of the frame and prevent the frame from folding completely. If users want to fold the frame, they move the pedal downwards to release the latched condition of the latch strut, then the frame is folded completely.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIG. 1 is a schematic view of the invention.

FIG. 2 is a schematic view of the invention showing a released folding structure and a frame starting to fold .

FIG. 3 is a schematic view of the invention showing the pedal in an operating condition.

FIG. 4 is a schematic view of the invention showing the frame in a folding movement after the pedal has been released.

FIG. 5 is a schematic view of the invention showing the frame in a folded condition.

FIG. 6 is a perspective view of the safety lock structure of the invention.

### DESCRIPTION OF THE PREFERRED EMBODIMENT

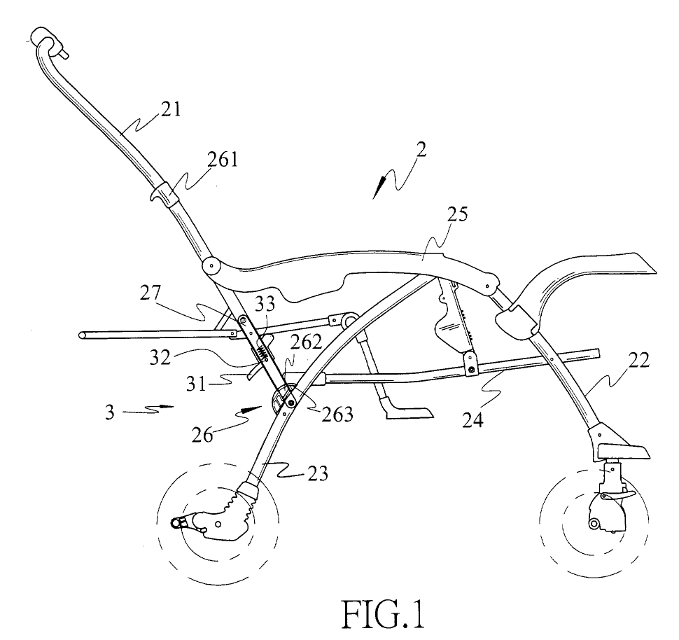

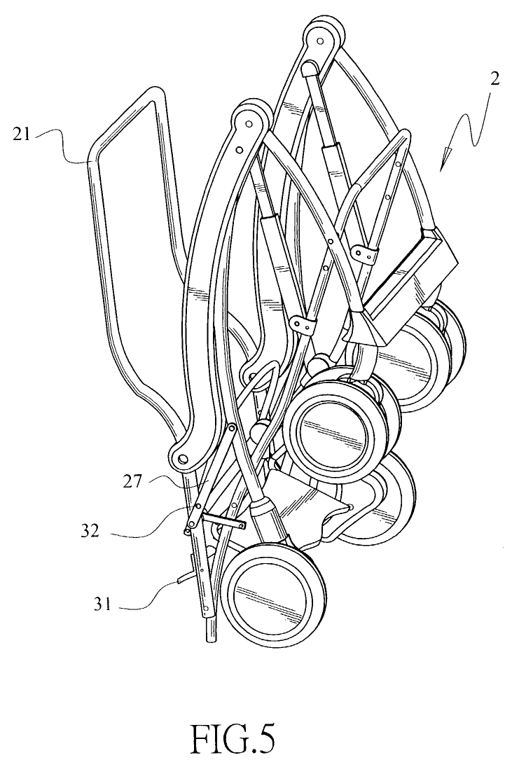

Referring to FIG. 1, the safety lock structure for strollers according to the invention mainly includes a folding frame 2 and a safety lock structure 3. The frame 2 consists of a handle tube 21, a front leg tube 22, a rear leg tube 23, a seat tube 24, an armrest 25 and a folding structure 26. The handle tube 21, front leg tube 22 and rear leg tube 23 are pivotally engaged with the armrest 25. There is a linkage plate 27 pivotally bridging the handle tube 21 and the rear leg tube 23. The folding structure 26 can be used to fold the frame 2 completely, as shown in FIG. 5.

The folding structure 26 includes a folding bar 261, an anchor bar 262 and an anchor dock 263. The anchor bar 262 and the folding bar 261 are installed on the handle tube 21. The anchor dock 263 is fixedly mounted on the rear leg tube 21. When the frame 2 is extended (as shown in FIG. 1), the anchor bar 262 is latched on the anchor dock 263 to maintain the frame 2 in extended condition. When there is a desire to release the frame 2, pull the release bar 261 to move the anchor bar 262 to escape from the anchor dock 263 through a linkage element (not shown in the drawings), then the frame may be folded completely.

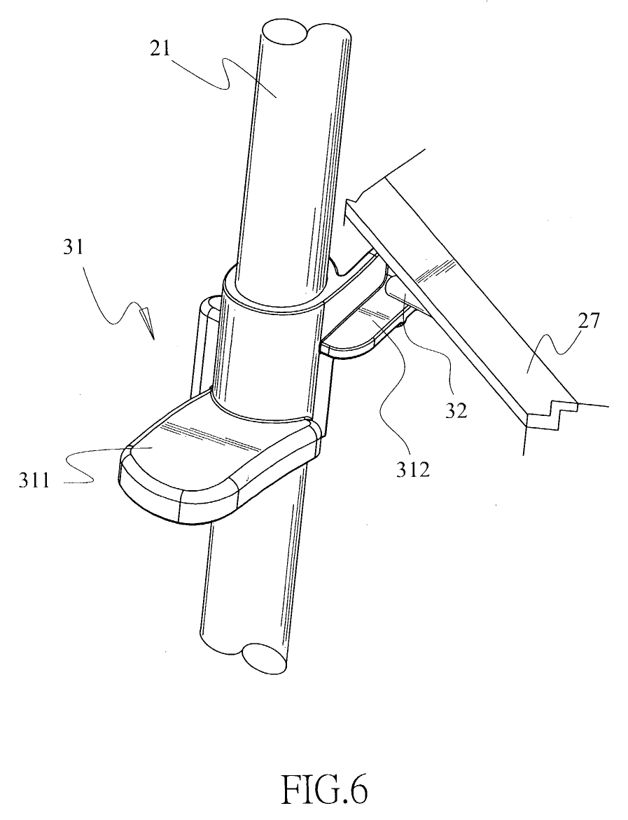

Referring to FIG. 6, the safety lock structure 3 includes a pedal 31, a latch strut 32 and an elastic element 33. The pedal 31 is mounted on the handle tube 21 and is positioned on a selected location by means of an elastic element 33. The pedal 31 includes at least a pedal tongue 311 and a retaining flange 312. The latch strut 32 is fixedly mounted onto the linkage plate 27 of the frame 2.

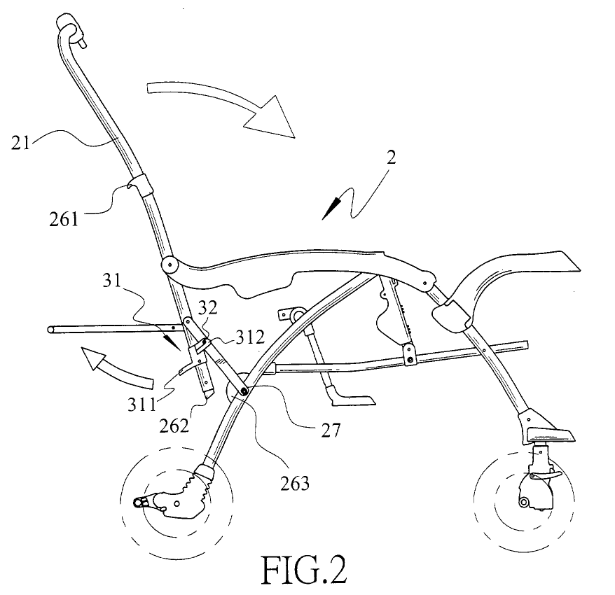

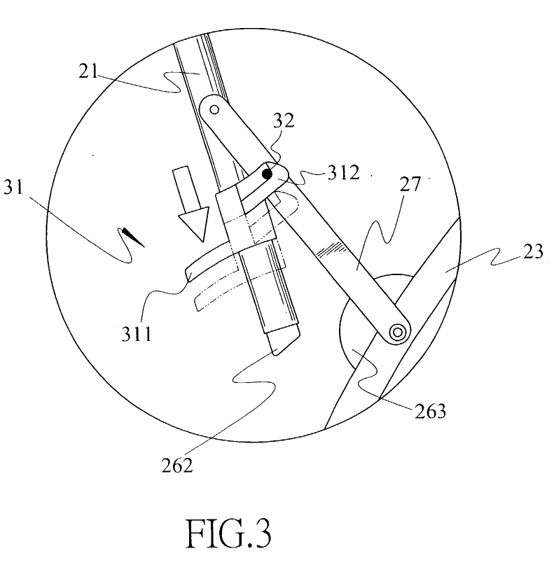

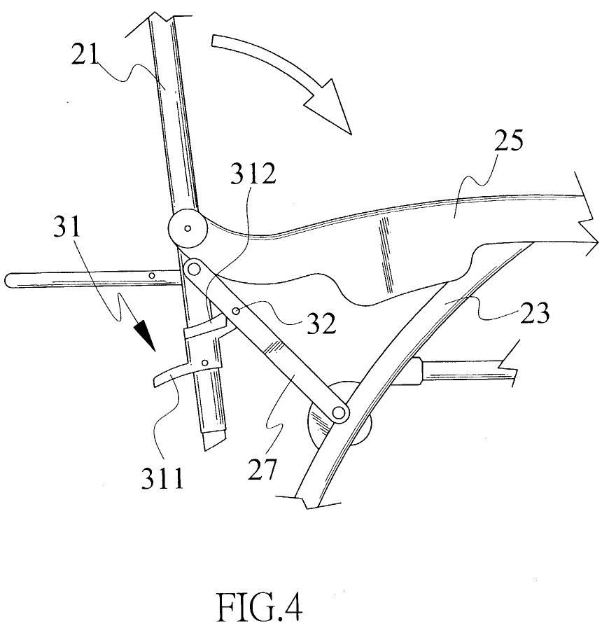

Referring to FIGS. 2, 3 and 4, when there is a desire to collapse the frame, pull the folding bar 261 to move the anchor bar 262 away from the anchor dock 263. The frame 2 may be turned and moved in folding direction, and the latch strut 32 located on the linkage plate 27 enters the retaining flange 312 of the pedal 31 such, that the frame 2 is latched and cannot be moved further for continuous folding. To fold the frame further, move and slide the pedal tongue 311 of the pedal 31 on the handle tube 21 to move the retaining flange 312 away from the latch strut 32, then the frame 2 can be folded completely.

By means of the construction and operation set forth above, the safety lock structure is separated from the folding structure. And the safety structure provides a latch and brake function after the folding structure is released and turned for a selected distance. Thereby users are reminded that the frame starts to fold at the initial folding stage, and the safety lock structure has to be released to complete the entire folding operation. Thus safety can be enhanced.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments not departing from the spirit and scope of the invention.

What is claimed is:

1. A safety lock structure for strollers to prevent a stroller frame constructed by pivotally engaging tubes from continuous turning and collapsing, comprising:
a pedal slidably mounted the stroller frame including a pedal tongue and a retaining flange; and
a latch strut fixedly mounted on the stroller frame;
wherein the latch strut enters the latch flange when the stroller frame is folding to prevent the stroller frame from collapsing continuously.

2. The safety lock structure for strollers of claim 1, wherein the stroller frame includes a handle tube, a front leg tube, a rear leg tube, a seat tube, an armrest and a linkage plate.

3. The safety lock structure for strollers of claim 1, wherein the pedal is slidably mounted on the handle tube.

4. The safety lock structure for strollers of claim 2, wherein the linkage plate is pivotally bridged between the handle tube and the rear leg tube and turnable when the stroller frame collapses.

5. The safety lock structure for strollers of claim 1, wherein the latch strut is fixedly mounted onto the linkage plate and turnable with the linkage plate.

6. The safety lock structure for strollers of claim 1, wherein the pedal is maintained on a selected location by means of an elastic element.
